(19) United States
(12) Patent Application Publication
(10) Pub. No.: US 2011/0242055 A1
(43) Pub. Date: Oct. 6, 2011

(54) COMPOSITE TOUCH SCREEN PANEL

(75) Inventors: Kwan-Sic Kim, Hwaseong-si (KR); Kwang-Cheol Choi, Gwacheon-si (KR)

(73) Assignee: SAMSUNG ELECTRONICS CO., LTD., Suwon-si (KR)

(21) Appl. No.: 13/077,187

(22) Filed: Mar. 31, 2011

(30) Foreign Application Priority Data
Apr. 2, 2010 (KR) 10-2010-0030406

(51) Int. Cl. G06F 3/042; G06F 3/041

(52) U.S. Cl. 345/175; 345/173

(57) ABSTRACT

A composite touch screen panel is applied to an electronic device. The touch screen panel includes a display module configured to output data and a spatial touch panel disposed at a top of the display module. The composite touch screen panel also includes an Acoustic Pulse Recognition (APR) panel arranged to overlap at a top of the spatial touch panel. The composite touch screen panel further includes a controller configured to sense a touch position sensed in the spatial touch panel and APR panel and perform a corresponding function of the device. The composite touch screen panel thereby integrates a spatial touch panel and an APR panel to exclude an existing silver (Ag) line and signal line, and maximizes a space utilization of a panel. Thus, the composite touch screen panel is capable of enabling a smooth performance of a precise touch and a long key function and drag operation.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Apr. 2, 2010 and assigned Serial No. 10-2010-0030406, the entire disclosure of which is hereby incorporated by reference.

### FIELD OF THE INVENTION

The present invention relates to a composite touch screen panel used as a data input/output means of an electronic device. More particularly, the present invention relates to a composite touch screen panel that, by integrating a spatial touch (3-Dimension (3D)) panel and a surface touch (2-Dimension (2D)) panel and permitting these operations together, compensates for the disadvantages of each touch panel and simultaneously increases the efficiency of a mounting space.

### BACKGROUND OF THE INVENTION

In general, various kinds of electronic devices include input units for data input and output units for data output. The input unit can be broadly classified into a key button device and the like, and the output device can be broadly classified into a display device including a Liquid Crystal Display (LCD) module.

In recent years, touch screen panels capable of implementing data input/output at the same position to remarkably reduce the volumes of electronic devices while diversifying functions thereof are being put in the market. The touch screen panel arranges a transparent touch panel above an LCD module, thereby achieving simultaneous input/output. Touch panels include various schemes such as resistive touch panels, capacitive touch panels, ultrasonic touch panels, light (infrared ray) sensing touch panels, electro-magnetic induction touch panels, Acoustic Pulse Recognition (APR) panels, and the like.

Among these touch panels, the light (infrared ray) touch panel recognizes a corresponding coordinate and performs a touch operation, by arranging a plurality of light sources (e.g., infrared Light Emitting Diodes (LEDs)) outside an LCD module at constant intervals, irradiating light into a specific space, and allowing a photo sensor to collect infrared rays reflected from an object (e.g., a finger and the like) in a space.

Because there is no direct touch on a touch screen surface, this spatial touch panel has an advantage of not being contaminated by foreign materials and avoiding damage to the touch screen surface. However, it is difficult or impossible to perform accurate and precise touch operation on a spatial touch panel, compared to a surface touch panel.

A typical surface touch panel includes an electrostatic touch panel and a decompression touch panel, and is possible to perform accurate and precise surface touch operations. However, a touch on a touch screen surface may contaminate or damage the screen surface. Also, because a silver (Ag) electrode line exists at an edge, the efficient use of space is difficult or impossible due to the extension of a black print region of a touch device.

Also, an APR panel may be constructed to face a plurality of input piezoelectric materials and reception piezoelectric materials at a fringe part of a glass substrate, and allow a reception piezoelectric material to receive a surface acoustic wave emitted from the input piezoelectric material and sense a touch depending on the attenuation non-attenuation of the surface acoustic wave. But, because this APR scheme cannot be aware of finger touch continuance time, there is a problem that a long key function or drag function is difficult or impossible.

Accordingly, researches on a variety of methods for compensating the disadvantages of the aforementioned touch panels are being conducted.

### SUMMARY OF THE INVENTION

To address the above-discussed deficiencies of the prior art, it is a primary object to provide at least the advantages described below. Accordingly, an aspect of the present invention is to provide a composite touch screen panel realized to integrate two different touch panels and compensate the disadvantage of each touch panel.

Another aspect of the present invention is to provide a composite touch screen panel including an Acoustic Pulse Recognition (APR) panel configured to perform a precise touch operation difficult to be realized by a spatial touch panel.

A further aspect of the present invention is to provide a composite touch screen panel including a spatial touch panel configured to smoothly perform a long key function and drag function difficult to be realized by an APR panel.

Yet another aspect of the present invention is to provide a composite touch screen panel realized to integrate a spatial touch panel and an APR panel and enable smooth performance of a precise touch operation and a long key function and drag function.

Still another aspect of the present invention is to provide a composite touch screen panel integrating a spatial touch panel and an APR panel, excluding an existing silver (Ag) electrode or signal line, minimizing a black print region of the panel, and maximizing a space utility of the panel.

The above aspects are achieved by providing a composite touch screen panel.

According to one aspect of the present invention, a composite touch screen panel applied to an electronic device is provided. The panel includes a display module configured to output data and a spatial touch panel disposed at a top of the display module. The panel also includes an APR panel arranged to overlap at a top of the spatial touch panel. The panel further includes a controller configured to sense a touch position sensed in the spatial touch panel and APR panel and perform a corresponding function of the device.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a portable terminal that includes a composite touch screen panel according to the present invention;

FIG. 2 illustrates a composite touch screen panel according to the present invention;

FIG. 3 is a cross section of a main part illustrating a combined state of FIG. 2 according to the present invention;

FIGS. 4A and 4B illustrate a construction of a spatial touch panel and an APR panel according to the present invention; and

FIG. 5 illustrates a state where a spatial touch panel and an APR panel are arranged to overlap with each other according to the present invention.

Throughout the drawings, it should be noted that like reference numbers are used to depict the same or similar elements, features, and structures.

### DETAILED DESCRIPTION OF THE INVENTION

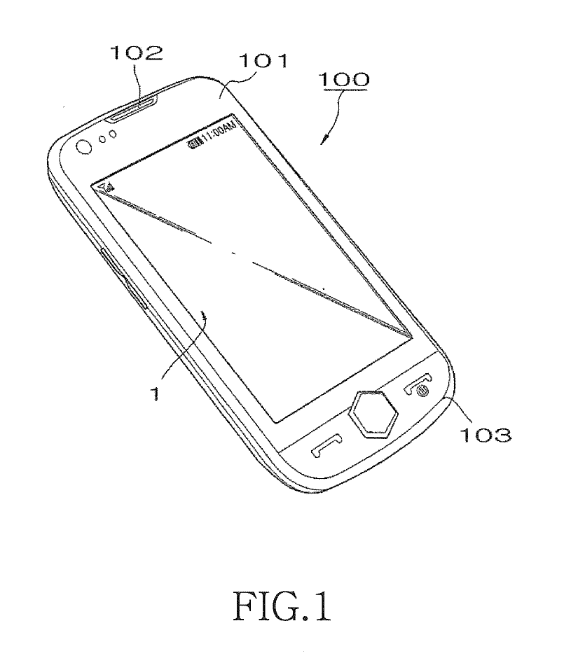

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged portable terminal. The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In the drawings, a portable terminal is illustrated, and a composite touch screen panel applied to the terminal is illustrated and described, but exemplary embodiments of the present invention are not limited to this. For example, a composite touch screen panel according to the present invention will be applicable to various electronic devices capable of having a touch screen device for data input/output.

FIG. 1 is a perspective diagram illustrating a portable terminal 100 that includes a composite touch screen panel according to the present invention. The composite touch screen panel 1 is installed in front 101 of the terminal 100. The composite touch screen panel 1 simultaneously supports a function of data input/output. Also, a speaker unit 102 is installed above the touch screen panel 1, and a microphone unit 103 is installed below the touch screen panel 1.

According to the present invention, the composite touch screen panel 1 may operate without a user's finger being in direct contact with a surface of a touch screen. This is caused by a spatial touch panel described later. However, a touch operation may be performed by a user making his/her finger contact with the touch screen and operating the composite touch screen panel 1. This is caused by an Acoustic Pulse Recognition (APR) panel mounted together with the spatial touch panel. That is, performance of various touch operations is possible according to user's preference. For example, when a relatively precise touch operation is needed, a user makes his/her finger contact with a touch screen surface to operate only the APR panel and perform a touch operation. When the user mainly wants a long key function or drag function, he/she mainly isolates his/her finger from a touch screen surface to perform a touch operation using the spatial touch panel.

Accordingly, it is desirable that the spatial touch panel and the APR panel operate mutual exclusively. That is, when the spatial touch panel operates, the APR panel does not operate and, when the APR panel operates, the spatial touch panel does not operate. However, the exemplary embodiments of the present invention are not limited to this. For instance, in other embodiments, when the spatial touch panel operates, the APR panel may or may not operate.

The aforementioned composite touch screen panel 1 is described below in detail.

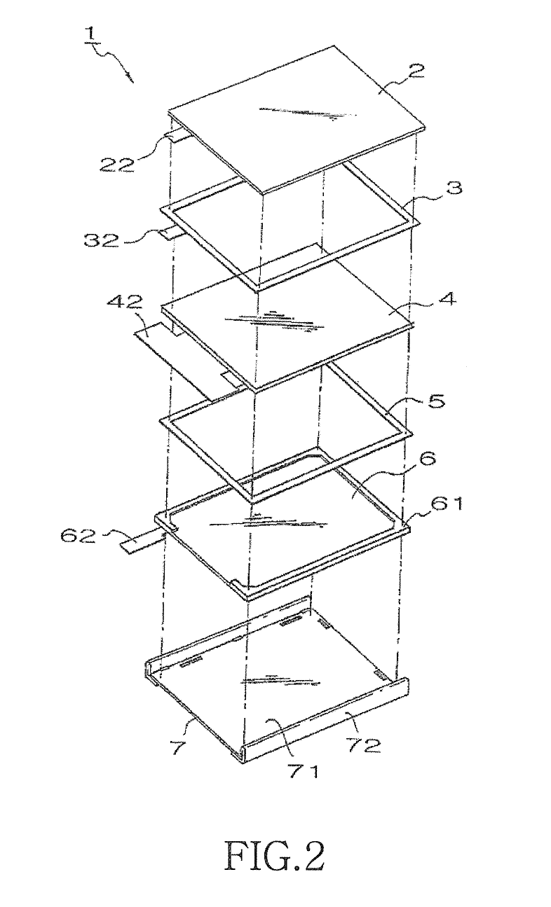

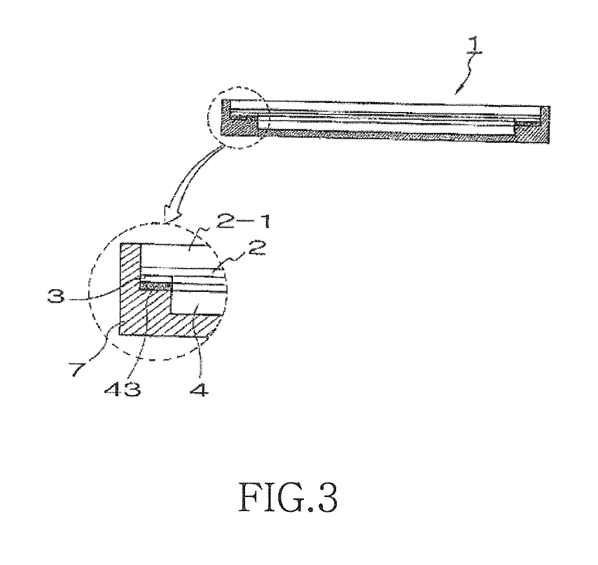

FIG. 2 is an exploded perspective diagram illustrating a composite touch screen panel 1 according to the present invention. FIG. 3 is a cross section of a main part illustrating a combined state of FIG. 2 according to the present invention.

The composite touch screen panel 1 according to the present invention includes a spatial touch panel 3 disposed above an LCD module 4 and an APR panel 2 installed above the spatial touch panel 3. A reinforcement plate 7 is further installed for accepting together and configuring the LCD module 4, the spatial touch panel 3, and the APR panel 2 as one assembly. A backlight unit 6 is further installed.

The reinforcement plate 7 includes a plane part 71 for housing the backlight unit 6 and a side part 72 upward bent at a predetermined height according to an edge of the plane part 71. This is to protect the accepted constituent elements from external impacts. Desirably, the reinforcement plate 7 can be formed of a Single UNIX Specification (SUS) material or synthetic resin material.

The backlight unit 6 laminated on the reinforcement plate 7 is surrounded with a frame 61 of synthetic resin material along an edge, facilitating lamination on the plane part 71 of the reinforcement plate 7.

The LCD module 4 can be a High Definition (HD) color Thin Film Transistor (TFT) LCD module, and can be attached to a top of the backlight unit 6 by a predetermined double-sided tape 5.

The spatial touch panel 3 and the APR panel 2 are sequentially laminated on the LCD module 4. Desirably, the APR panel 2 can be directly formed on a bottom surface of a top glass layer (2-1 of FIG. 3) of the touch screen panel 1. Also, as illustrated in FIG. 3, an Optical Clear Adhesive (OCA) (43 of FIG. 3) can be applied and attached between the LCD panel 4 and the spatial touch panel 3.

Also, the spatial touch panel 3 includes a hollow space, and is installed to overlap in a way of attachment to a bottom of the APR panel 2. The hollow space can be formed equal to an active region of the LCD module 4.

Desirably, the APR panel 2, the spatial touch panel 3, the LCD module 4, and the backlight unit 6 can perform power supply and data transmission by signal lines such as Flexible Printed Circuits (FPCs) 22, 32, 42, and 62 drawn out to the external area.

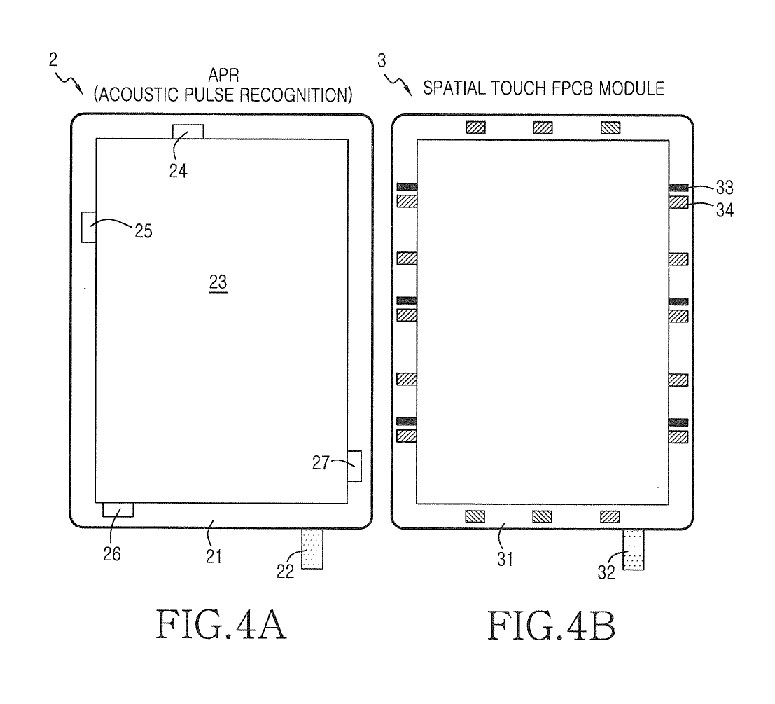

FIGS. 4A and 4B are diagrams illustrating a construction of a spatial touch panel and an APR panel according to the present invention.

FIG. 4A is an APR panel, and FIG. 4B is a spatial touch panel.

As illustrated in FIG. 4A, the APR panel 2 includes a non-piezoelectric substrate 21 formed of glass materials, a plurality of input piezoelectric materials 24 and 25 exciting surface acoustic waves at one end of each of the X and Y directions of the non-piezoelectric substrate 21, and a plurality of reception piezoelectric materials 26 and 27 facing the input piezoelectric materials 24 and 25 and receiving surface acoustic waves at the other end of each of the X and Y directions of the non-piezoelectric substrate 21.

Accordingly, the APR panel 2 inputs an electric signal to each of the input piezoelectric materials 24 and 25 to excite a surface acoustic wave, and propagates the surface acoustic wave onto the non-piezoelectric substrate 21. The reception piezoelectric materials 26 and 27 receive the propagated surface acoustic wave. Accordingly, if a finger or object comes in contact with a propagation path for a surface acoustic wave on the non-piezoelectric substrate 21, the surface acoustic wave is attenuated, so the APR panel 2 detects the attenuation or non-attenuation of levels of receive signals of the reception piezoelectric materials 26 and 27 to detect a contact or non-contact and its contact position. An internal space 23 of the non-piezoelectric substrate 21 is a detection region capable of detecting a touch position. A fringe part of the non-piezoelectric substrate 21 can be a frame region where the input piezoelectric materials 24 and 25 and the reception piezoelectric materials 26 and 27 are installed. Also, the fringe part may be utilized as a reflective array for reflecting, at a predetermined angle, electronic waves emitted from the input piezoelectric materials 24 and 25 such that the reception piezoelectric materials 26 and 27 can receive the electronic waves.

As illustrated in FIG. 4B, the spatial touch panel 3 sequentially mounts, at predetermined intervals, a plurality of Light Emitting Diodes (LEDs) 33 for irradiating infrared rays into an FPC 31 of an edge form having an opening formed at its center, and a plurality of photo sensors 34 for receiving light irradiated from the LEDs 33.

Accordingly, the LEDs 33 irradiate the light upward at a predetermined angle (e.g., about 45 degrees). When a finger gets closer to a corresponding position, the irradiated light is reflected from the finger and is received by a corresponding photo sensor 34, thus determining a corresponding touch position.

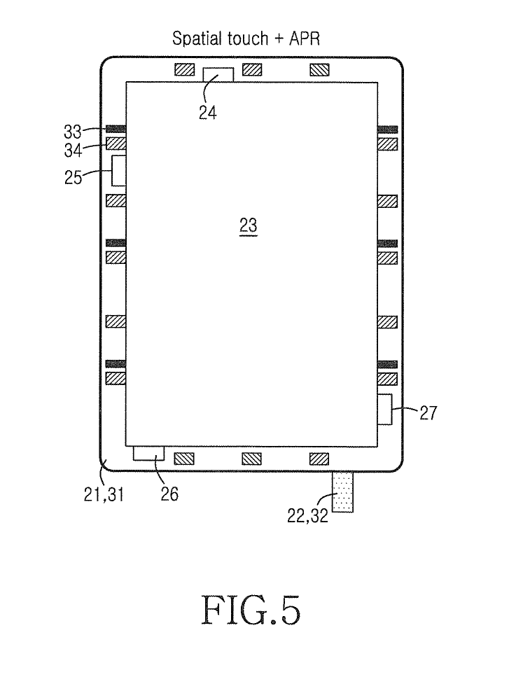

FIG. 5 is a construction diagram illustrating a state where a spatial touch panel and an APR panel are arranged to overlap with each other according to the present invention.

As illustrated in FIG. 5, an APR panel and a spatial touch panel are attached using a method such as bonding or taping and the like to overlap with each other. A fringe part installing respective piezoelectric materials 24, 25, 26, and 27 of the APR panel is made consistent with the spatial touch panel 3. A contact region 23 of the APR panel is an active region of an LCD module 4. Also, in some embodiments, it is desirable to install the piezoelectric materials 24, 25, 26, and 27 of the APR panel and the LEDs 33 and photo sensors 34 of the spatial touch panel in a non-overlap position.

Thus, the use of the APR panel 2 excludes a need for an Ag electrode and signal line formed to have a predetermined width in an existing electrostatic touch panel and compression touch panel. Thus, for the same panel, the contact region 23 of the APR panel can be a little more expanded. This represents the expansion of the active region of the LCD module 4. As a result, a space utilization of a product can be maximized due to the minimization of a non-used black print region of the touch screen panel.

As described above, exemplary embodiments of the present invention integrate a spatial touch panel and an APR panel to exclude an existing Ag line and signal line and maximize a space utilization of a panel, and can enable smooth performance of a precise touch and a long key function and drag operation.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A composite touch screen panel applied to an electronic device, the composite touch screen panel comprising:
a display module configured to output data;
a spatial touch panel disposed at a top of the display module;
an Acoustic Pulse Recognition (APR) panel arranged to overlap at a top of the spatial touch panel; and
a controller configured to sense a touch position sensed in the spatial touch panel and APR panel and perform a corresponding function of the device.

2. The composite touch screen panel of claim 1, wherein the spatial touch panel comprises:
a Flexible Printed Circuit (FPC) of an edge form having an opening of a predetermined size;
a plurality of Light Emitting Diodes (LEDs) mounted at constant intervals on the FPC and irradiating light; and
a plurality of photo sensors configured to selectively receive light irradiated from the LEDs and sense a corresponding spatial touch position.

3. The composite touch screen panel of claim 2, wherein the APR panel comprises:
a non-piezoelectric substrate formed of transparent glass material;
a plurality of input piezoelectric materials mounted over an X axis and a Y axis at constant intervals along a fringe part of an edge of the non-piezoelectric substrate; and
a plurality of reception piezoelectric materials mounted over the X axis and Y axis to receive electronic waves emitted from the input piezoelectric materials,
wherein the APR panel is configured to sense a touch region where a transmission electronic wave is attenuated and received.

4. The composite touch screen panel of claim 3, wherein a fringe part of the APR panel and the FPC of the spatial touch panel are disposed to overlap with each other.

5. The composite touch screen panel of claim 4, wherein the piezoelectric materials of the APR panel and the LEDs and photo sensors of the spatial touch panel are disposed in a non-overlap position.

6. The composite touch screen panel of claim 4, wherein an active region of the display module, a contact region of the APR panel, and the FPC of the spatial touch panel are formed to have openings of the same size.

7. The composite touch screen panel of claim 4, wherein the spatial touch panel and the APR panel are attached to each other by bonding or taping.

8. The composite touch screen panel of claim 1, wherein the controller operates the spatial touch panel and the APR panel mutually exclusively.

9. The composite touch screen panel of claim 8, wherein, when the APR panel operates, the controller does not operate the spatial touch panel.

10. The composite touch screen panel of claim 1, wherein a backlight unit is further installed at a bottom of the display module, and is fixed to a reinforcement plate of its bottom and is used as one assembly.

11. A portable terminal, comprising:
a speaker unit;
a microphone unit; and
a composite touch screen panel, the composite touch screen panel comprising:
a display module configured to output data;
a spatial touch panel disposed at a top of the display module;
an Acoustic Pulse Recognition (APR) panel arranged to overlap at a top of the spatial touch panel; and
a controller configured to sense a touch position sensed in the spatial touch panel and APR panel and perform a corresponding function of the device.

12. The portable terminal of claim 11, wherein the spatial touch panel comprises:
a Flexible Printed Circuit (FPC) of an edge form having an opening of a predetermined size;
a plurality of Light Emitting Diodes (LEDs) mounted at constant intervals on the FPC and irradiating light; and
a plurality of photo sensors configured to selectively receive light irradiated from the LEDs and sense a corresponding spatial touch position.

13. The portable terminal of claim 12, wherein the APR panel comprises:
a non-piezoelectric substrate formed of transparent glass material;
a plurality of input piezoelectric materials mounted over an X axis and a Y axis at constant intervals along a fringe part of an edge of the non-piezoelectric substrate; and
a plurality of reception piezoelectric materials mounted over the X axis and Y axis to receive electronic waves emitted from the input piezoelectric materials,
wherein the APR panel is configured to sense a touch region where a transmission electronic wave is attenuated and received.

14. The portable terminal of claim 13, wherein a fringe part of the APR panel and the FPC of the spatial touch panel are disposed to overlap with each other.

15. The portable terminal of claim 14, wherein the piezoelectric materials of the APR panel and the LEDs and photo sensors of the spatial touch panel are disposed in a non-overlap position.

16. The portable terminal of claim 14, wherein an active region of the display module, a contact region of the APR panel, and the FPC of the spatial touch panel are formed to have openings of the same size.

17. The portable terminal of claim 14, wherein the spatial touch panel and the APR panel are attached to each other by bonding or taping.

18. The portable terminal of claim 11, wherein the controller operates the spatial touch panel and the APR panel mutually exclusively.

19. The portable terminal of claim 18, wherein, when the APR panel operates, the controller does not operate the spatial touch panel.

20. The portable terminal of claim 11, wherein the composite touch screen panel further comprises a backlight unit disposed at a bottom of the display module and fixed to a reinforcement plate at the bottom of the display module and used as one assembly.
